(19) United States
(12) Patent Application Publication
(10) Pub. No.: US 2020/0034480 A1
(43) Pub. Date: Jan. 30, 2020

(54) AGILE SEMANTIC FRAMEWORK

(71) Applicant: SAP SE, Walldorf (DE)

(72) Inventors: Gerrit Simon Kazmaier, Vancouver (CA); Bare Said, St. Leon-Rot (DE); Tobias Hoehmann, Walldorf (DE); Jan Teichmann, Neustadt/Weinstrasse (DE)

(21) Appl. No.: 16/048,863

(22) Filed: Jul. 30, 2018

(51) Int. Cl. G06F 17/30

(52) U.S. Cl. CPC G06F 17/30684; G06F 17/30613

(57) ABSTRACT

A computer-implemented method for defining queries based on agile semantic objects (ASOs) is provided. Data definitions defining data structures are acquired from a plurality of data sources. The data definitions include information for fields, semantics, and data relationships and semantics for use in analytical environments. Using the data definitions, metadata is defined for ASOs representing data objects in the data definitions. The metadata and the ASOs are stored in an ASO repository. A request for creating a query is received. Metadata representing the ASOs is provided in response to the request for use in a query designer interface. A query based on selected ones of the ASOs is received from the query designer interface. The query is stored in a query repository. A runtime object for executing the query is provided.

### BACKGROUND

Various analytical products can combine business intelligence (BI), planning, and predictive capabilities into one or more tools. The tools can include, for example, end-user centric tools and cloud-only dashboarding tools. However, as an increased number of new data sources become available, these tools are not typically equipped to handle data formats and metadata associated with the new data sources.

### SUMMARY

The present disclosure describes techniques for defining and using agile semantic objects. In an implementation, a computer-implemented method comprises: acquiring, from a plurality of data sources, data definitions defining data structures, the data definitions including information for fields, semantics, and data relationships and semantics for use in analytical environments; defining, using the data definitions, metadata for agile semantic objects (ASOs) representing data objects in the data definitions; storing the metadata and the ASOs in an ASO repository; receiving a request for creating a query; providing, in response to the request and for use in a query designer interface, metadata representing the ASOs; receiving, from the query designer interface, a query based on selected ones of the ASOs; and storing the query in a query repository; and providing a runtime object for executing the query.

The described subject matter can be implemented using a computer-implemented method; a non-transitory, computer-readable medium storing computer-readable instructions to perform the computer-implemented method; and a computer-implemented system comprising one or more computer memory devices interoperably coupled with one or more computers and having tangible, non-transitory, machine-readable media storing instructions that, when executed by the one or more computers, perform the computer-implemented method/the computer-readable instructions stored on the non-transitory, computer-readable medium.

The subject matter described in this specification can be implemented to realize one or more of the following advantages. First, agile semantic objects can be used for data definitions associated with entity-relationship models, cube-dimension models, and query models. Second, agile semantic objects can be used for data definitions associated with pre-defined reports, information technology (IT)-governed reports, and ad-hoc reports. Third, agile semantic objects can be used for data definitions associated with legacy data and new data.

The details of one or more implementations of the subject matter of this specification are set forth in the Detailed Description, the Claims, and the accompanying drawings. Other features, aspects, and advantages of the subject matter will become apparent to those of ordinary skill in the art from the Detailed Description, the Claims, and the accompanying drawings.

### DESCRIPTION OF DRAWINGS

FIG. 1 is a block diagram illustrating examples of dimensions of agility provided by the agile semantics framework (ASF), according to an implementation of the present disclosure.

FIG. 2 is a swim lane diagram illustrating an example of a process flow for creating queries using the query designer component, according to an implementation of the present disclosure.

FIG. 3 is a screenshot of an example of a user interface for building a query, according to an implementation of the present disclosure.

FIG. 4 is a screenshot of an example of a simple data definition, according to an implementation of the present disclosure.

FIG. 5 is a screenshot of the data definition, according to an implementation of the present disclosure.

FIG. 6 is a flowchart illustrating an example of a computer-implemented method for defining and using agile semantic objects (ASOs), according to an implementation of the present disclosure.

FIG. 7 is a block diagram illustrating an example of a computer-implemented system used to provide computational functionalities associated with described algorithms, methods, functions, processes, flows, and procedures, according to an implementation of the present disclosure.

Like reference numbers and designations in the various drawings indicate like elements.

### DETAILED DESCRIPTION

The following detailed description describes a system and a method for defining and using agile semantic objects (ASOs), and is presented to enable any person skilled in the art to make and use the disclosed subject matter in the context of one or more particular implementations. Various modifications, alterations, and permutations of the disclosed implementations can be made and will be readily apparent to those of ordinary skill in the art, and the general principles defined can be applied to other implementations and applications, without departing from the scope of the present disclosure. In some instances, one or more technical details that are unnecessary to obtain an understanding of the described subject matter and that are within the skill of one of ordinary skill in the art may be omitted so as to not obscure one or more described implementations. The present disclosure is not intended to be limited to the described or illustrated implementations, but to be accorded the widest scope consistent with the described principles and features.

Analytics systems, applications, and products (for example, SAP Analytics Cloud (SAC)) can combine business intelligence (BI), planning, and predictive capability use cases on a set of data into one tool. In the case of SAC as a particular example, SAC is an end-user centric, Cloud-computing-only dashboarding tool. The present disclosure describes how SACs internal integration feature set can be improved by broadened and deepened to extend, for example, original equipment manufacturer (OEM) support. Among other things, with the described improvement, a number of applications that embed SAC can be increased. By being able to incorporate and use an increasing number of data sources, a number of data integration protocols and tools can grow, which increases a number of metadata types that can be accessed.

With regard to data accessibility, SAC provides a rich set of capabilities which can be categorized into two groups. Using a live data access capability, SAC can connect to application data wherever the application data happens to exist. Using a data acquisition capability, SAC can acquire and upload application data into an SAP analytics cloud.

The present disclosure focuses on live data access capability for several reasons. The following reasons can help to explain why clients (especially for on-premises applications) prefer the live data access capability.

First, no data replication is needed (meaning no data needs to be copied), as SAC can connect to the live application data wherever the application data happens to exist. Avoiding data replication can have a real-time advantage in that there is little to no time lag and the data remains consistent. Another advantage with respect to data replication is related to data size, which is relevant when dealing with large data volumes. This is because, in some implementations, overall tenant size can be capped (for example, at 1 terabyte (TB)), making data replication difficult, computationally-expensive, or impossible given computational, network, or computing system performance requirements.

Second, data does not have to leave the client's network. Allowing data to remain where it is stored can provide a security advantage. Clients can avoid putting their data in the Cloud or exposing their data to public internet traffic. This can also save time and reduce security risks that would otherwise be required by securing replicated data with the same authorizations as with a data source, which may not always be possible.

Data acquisition capability, however, can be an easier and faster approach when users want to achieve a first integration or to obtain quick results in SAC. Also, there can be some limitations for the live data access capability that can make the data acquisition capability a better solution in some cases for integrating data into SAC. For example, feature restrictions (in the live data access capability) can require that planning scenarios require data to be local in SAC). In another example, the live data access capability can have certain “remote blending” limitations.

Data access protocols and capabilities are different for the live data access capability and the data acquisition capability. For example and in some implementations, the live data access capability runs SAC's proprietary INA data access protocol over the wire and through Hypertext Transfer Protocol Secure (HTTPS), which is one of SAC's most valuable attributes. On the other hand, the data acquisition capability supports a number of widely-accepted data sources and data integration formats from SAP sources (for example, OPEN DATA PROTOCOL (OData), FIELDGLASS, CONCUR, and SAP HYBRIS CLOUD FOR CUSTOMER) and non-SAP sources (for example, GOOGLE DRIVE, GOOGLE BIGQUERY, and SALESFORCE).

Although there are various ways to improve either capability (that is, live data access or data acquisition), the agile semantics framework (ASF) is designed to enhance data access capabilities for the live data access capability. The following are features of the ASF.

First, the ASF can be seen as a “metadata adapter”. For example, users can use the ASF to define metadata that the system can understand, including defining the semantics that are associated with the metadata.

Second, the ASF can be used to define the metadata that SAC can understand when connecting to remote data sources. Understanding the metadata can allow SAC to send INA queries to the remote data sources. Complexity of the metadata can range from relatively simple entity-relationship models (ERMs) to more complex, or enriched, models. The metadata can define dimensions and fields that can be used to annotate a structural description of the underlying data.

Third, the ASF can be used to define semantics of data structures in data sources with which SAC can connect. For example, for a pure entity-relationship model, SAC alone can be relied upon to define dimensions, cubes, measures, titles, texts, labels, and GeoColumns. However, using the ASF, all or part of these definitions can come from the remote data sources. The capability to obtain definitions from the remote data sources is one aspect of the “agility” of the ASF.

Fourth, while loading simple data structures, an intelligent automated discovery of semantical information can be applied based on pure technical properties or ontological knowledge of former patterns that were previously learned. For example, while uploading new data definitions, the ASF can determine that similarities exist between the new data definitions and data definitions that were uploaded previously. For example, the ASF can make a determination that “these X fields are the client name fields” or “these Y fields are employee title fields”, meaning that the data definitions fit into patterns of human resources structures.

Fifth, the ASF can operate as a framework that offers ad-hoc data view modeling capabilities for end-users. As such, the ASF can combine self-service reporting with centrally- or IT-governed analytics. These features are other dimensions of the ASF's “agility.” The ASF also provides flexible analytics deployment modes which users can use, for example, to discover their own data models and build dashboards.

Sixth, the ASF's enablement of combined ad-hoc and central analytics can apply to metadata and artifacts as well as to analytics content. These capabilities can be used with predefined and legacy content. In addition to strong ad-hoc content building capabilities, the ASF can support ad-hoc content building on top of predefined content.

Typically, BI tools define their own semantical models and require consumers to build artifacts and content following those models in the tool. SAC and the ASF can provide an open and agile “interface object” and framework that allows for connectivity and extensibility to foreign semantic models. This can provide access to foreign metadata types.

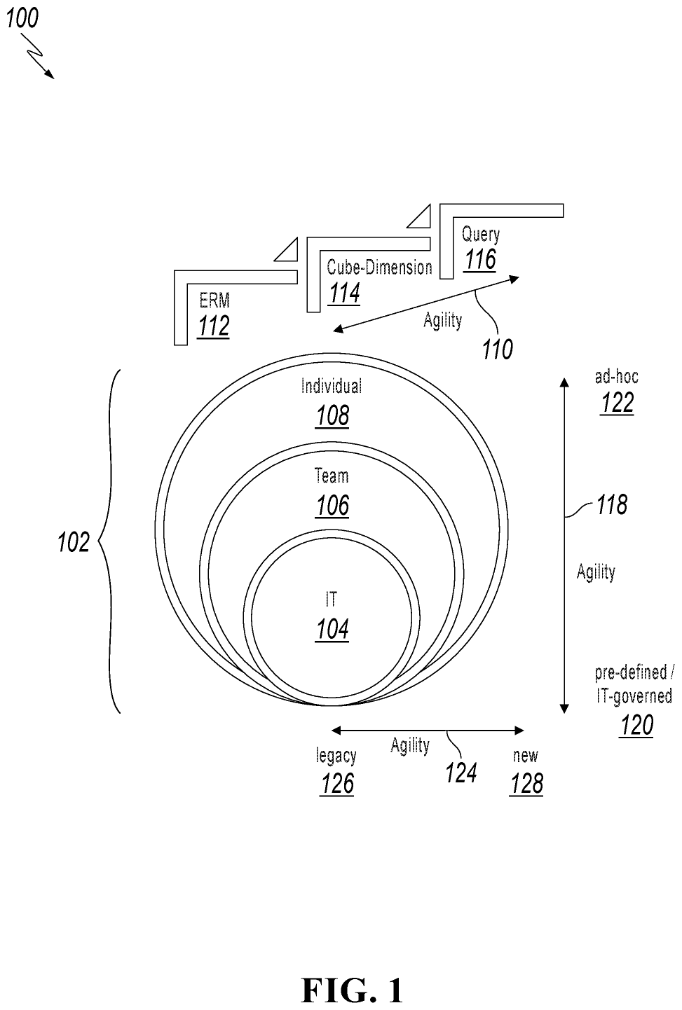

FIG. 1 is a block diagram illustrating examples of dimensions 100 of agility provided by the ASF, according to an implementation of the present disclosure. Data 102 that is used by the ASF can include IT-level data 104. Extensions to the IT-level data 104 can include team-level data 106 and individual-level data 108. A first dimension of agility 110 can be provided because the ASF can provide ASOs that span ERMs 112, cube-dimensions models 114, and query models 116 (for example, that were built in other analytics tools). A second dimension of agility 118 can be provided because the ASF can support pre-defined and IT-governed reports 120 and ad hoc reports 122, or combinations of the two. Further, using “simple ASO data structures,” a user can define new SAC queries in an ad-hoc manner. A third dimension of agility 124 can be provided because the ASF can provide ASOs (and support the generation of queries using) legacy data 126 and new data 128.

Some ASF implementations can contain the following entities and functions. ASF metadata format, considered to be part of an ASF framework, can be defined in JAVASCRIPT OBJECT NOTATION (JSON) format. The JSON format can share similarities with core data services (CDS) and .edmx formats with a number of analytical annotations that describe semantic capabilities. The ASF can include the use of a metadata interface object (that is, an agile semantic object (ASO)) that can typically be in JSON format, although other formats are possible, including extensible markup language (XML). An ASO repository can store ASOs using, for example, software installed on OEMs, where JSON files are stored. The ASO repository can include a set of database tables and views that are stored near the actual data, making paths and views easier to implement.

The ASF includes a query designer component (that uses and includes software and a user interface) that can provide query design capabilities, including semantic enrichment of basic semantic models to create rich semantic queries. The queries can be created after auto-discovery has been applied. The query designer component can generate runtime query objects as well as a default SAC model and a default SAC story. The ASF can include functions for discovering large “landscapes” of data structured in data source systems, from which the ASF can define super-structures using domains. The domains can be used within the query designer component to expose hierarchies of objects that are associated with corresponding ASOs. In some implementations, the query designer component can be written in JAVA or another computing language.

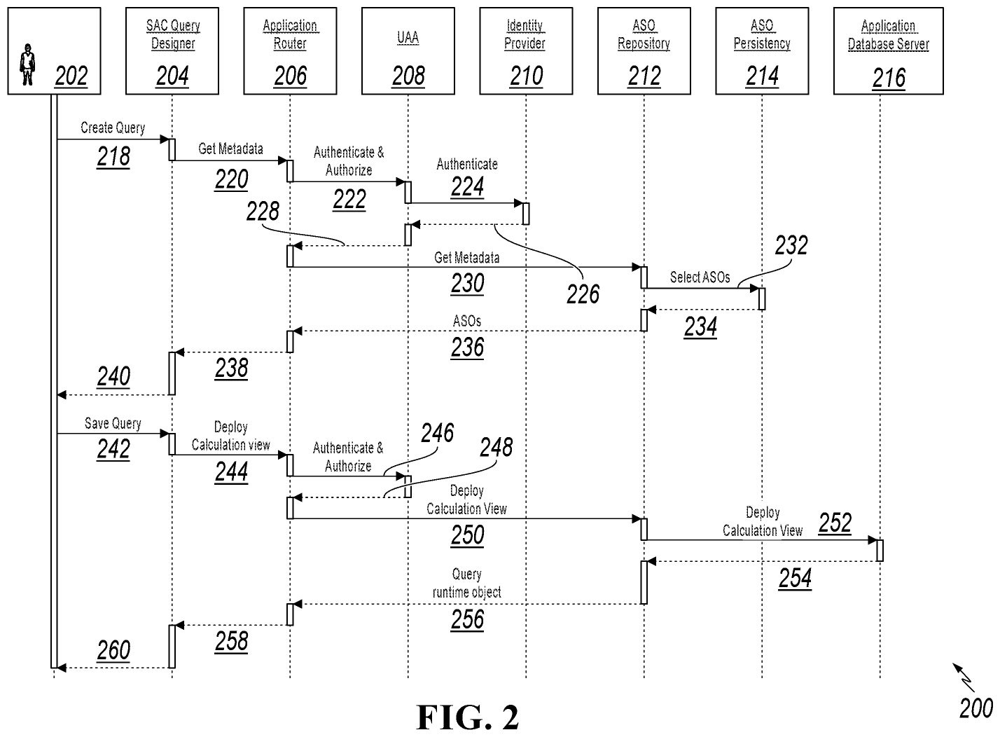

FIG. 2 is a swim lane diagram illustrating an example of a process flow 200 for creating queries using the query designer component, according to an implementation of the present disclosure. The process flow 200 can be used, for example, to create queries based on the ASOs after the ASOs have been deployed into the ASO repository (for example, stored in the Cloud or on premises). ASO deployment can be done through software shipments or ad-hoc through calling, for example, of lines-of-business (LOBs) or partner application programming interfaces (APIs) that can return ASOs. ASOs can be based on data definitions comprised of JSON files containing text. When ASOs are stored, the ASOs can be indexed for searchability, allowing users to search for ASOs using, for example, titles or keywords.

The process flow 200 includes steps that are performed among entities 202-216 that include or use the ASF and its features. The entities 202-216 can include a user 202 (who can design queries, for example), an SAC query designer 204 (for example, the query designer component of the ASF), an application router 206, a user authentication and authorization (UAA) module 208, an identity provider 210, an ASO repository 212, an ASO persistency 214, and a database server 216.

The process flow 200 can begin when the user provides a request 218 to begin creating a query using the SAC query designer 204. The SAC query designer 204 can provide a request 220 for metadata to the application router 206.

Before the metadata (such as metadata in the form of ASOs) can be provided to the user 202, however, the application router 206 can perform steps to authenticate the user 202. The application router 206 can send an authentication request 222 to the user authentication and authorization module 208, which can send an authentication request 224 to the identity provider 210. Assuming that the user 202 is authenticated, the identity provider 210 can send a reply 226 back to the authentication and authorization module 208, which can send a reply 228 back to the application router 206 indicating that the user 202 has been authenticated.

Once the user is authenticated, the application router 206 can send a request 230 for metadata to the ASO repository 212, which can send a request 232 to select ASOs to the ASO persistency 214. The ASO persistency 214 can provide a response 234 back to the ASO repository 212, which can send a response 236 (for example, ASOs) back to the application router 206 that includes the ASOs. The application router 206 can provide the ASOs in a response 238 to the SAC query designer 204 which can provide and display the ASOs 240 to the user 202. At this point, the user has access to the ASOs from which a query can be created.

The process flow 200 can continue when the user provides a request 242 to save a query using the SAC query designer 204. The query can be created by the user 202 using the ASOs presented in the query designer component of the ASF, for example. The SAC query designer 204 can provide a request 244 for deploying a calculation view to the application router 206. The calculation view can be (or correspond to) a query that the user 202 wants to plug into a dashboard, for example.

The application router 206 can send an authentication request 246 to the authentication and authorization module 208. Upon successful authentication of the user 202, the authorization module 208 can send a reply 248 back to the application router 206 indicating that the user 202 has been authenticated. Then, the application router 206 can send a request 250 for deploying the calculation view to the ASO repository 212 which can send a corresponding request 252 to the database server 216. Once the database server 216 has stored the query, the database server 216 can provide a response 254 to the ASO repository 212 which can send a response 256 (for example, including a query runtime object) to the application router 206. The application router 206 can send a response 258 to the SAC query designer 204. The response 258 can include the query runtime object. In some implementations, the SAC query designer 204 can insert the query runtime object into a dashboard or some other location identified by the user 202. The SAC query designer 204 can provide a response 260 (for example, by displaying a message) to the user 202 indicating that the query has been saved.

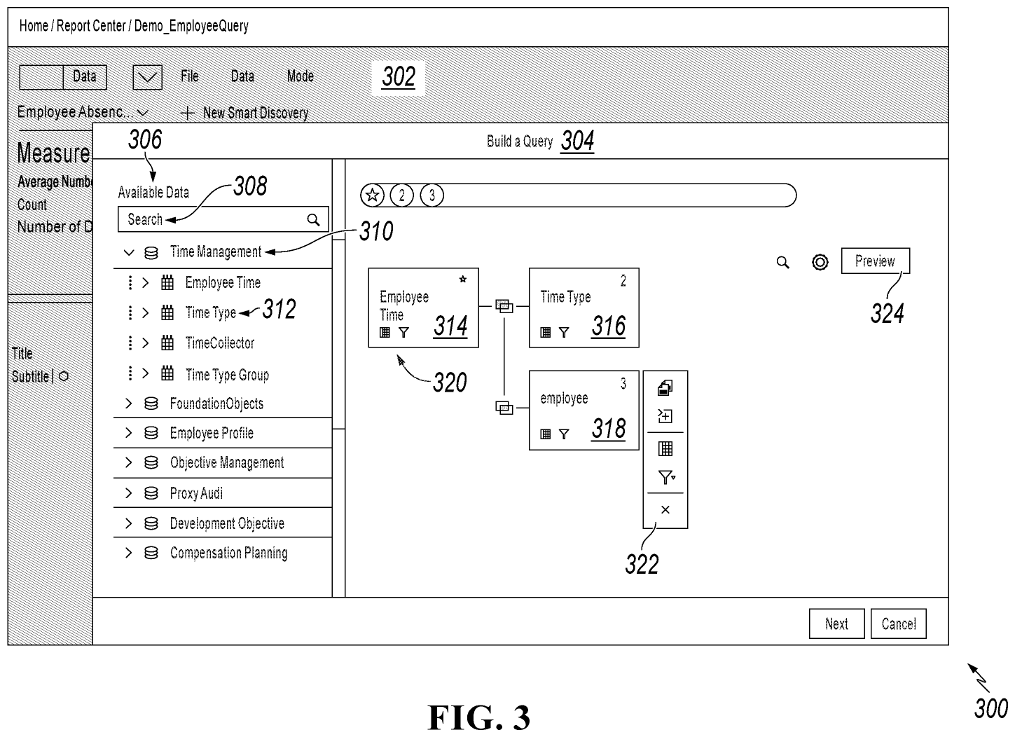

FIG. 3 is a screenshot of an example of a user interface 300 for building a query, according to an implementation of the present disclosure. The user interface 300 can implement the query designer component, for example.

The user interface 300 can include tabs 302 or other controls for navigating to the query builder area 304. An available data area 306 can display a list of various types of data objects from which the user can build a query. The user can use a search control 308 to search for particular ASOs that have been previously indexed by title or keyword.

The ASOs that are presented in the available data area 306 can be organized hierarchically. For example, time management 310 can be a heading that lists time management-related ASOs, including a time type ASO 312. When the time type ASO 312 is selected, the ASO 312 is taken into the query builder area 304 which can display elements of the time type ASO 312 in a deeper drill-down level. The query builder area 304 can include, for example, an employee time element 314, a time type element 316, and an employee element 318. Controls 320 can be used to display metadata for selected elements. Controls 322 can be used for controlling how the query is to be built and executed. Elements displayed in the query builder area 304 can be connected with lines that show relationships between the elements. Moreover, notations can be displayed with the elements and connecting lines that identify cardinality relationships (for example, 1:1, 1:n, or other types of relationships) and whether elements are optional. User selection of particular elements can cause the elements to be incorporated into the query. A preview control 324 can be selected by the user to view a query that corresponds to current selections made by the user in the query builder area 304.

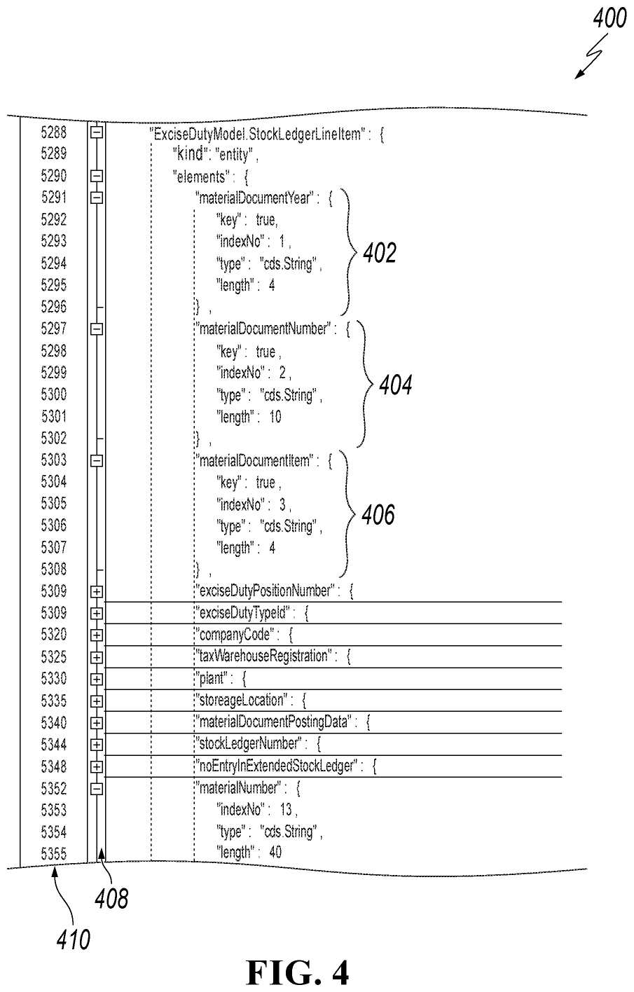

FIG. 4 is a screenshot of an example of a simple data definition 400, according to an implementation of the present disclosure. The data definition 400 includes ISOs 402-406 for elements materialDocumentYear, materialDocumentNumber, and materialDocumentItem, respectively. The data definition 400 can include information that specifies whether a particular ISO is a key field, whether the ISO is indexed, the ISO's data type, and the ISO's length or size. The data definition 400 can be presented as an editable data definition, allowing a user to scroll through the data definition 400 to locate particular ISOs. Controls 408 can be used to hide, expand, or collapse detailed data definition information for particular ISOs. As indicated by values of line numbers 410, the information shown in FIG. 4 is a small subset of a much larger data definition. The format of the data that appears in the data definition 400 can be input, by a user, in the same format or in a different format.

Data definitions can be defined by a user, for example, during the development of an application (including data structures and user interfaces), where the data definitions are defined for the data used by the application. The information that is included in the data definitions can pertain to data objects and tables that may be relevant to user. As such, the data definitions can represent views exposed to users for actual tables. At this point, analytical developers can use the ASOs to obtain information about the data, such as by building queries that are based on the ASOs.

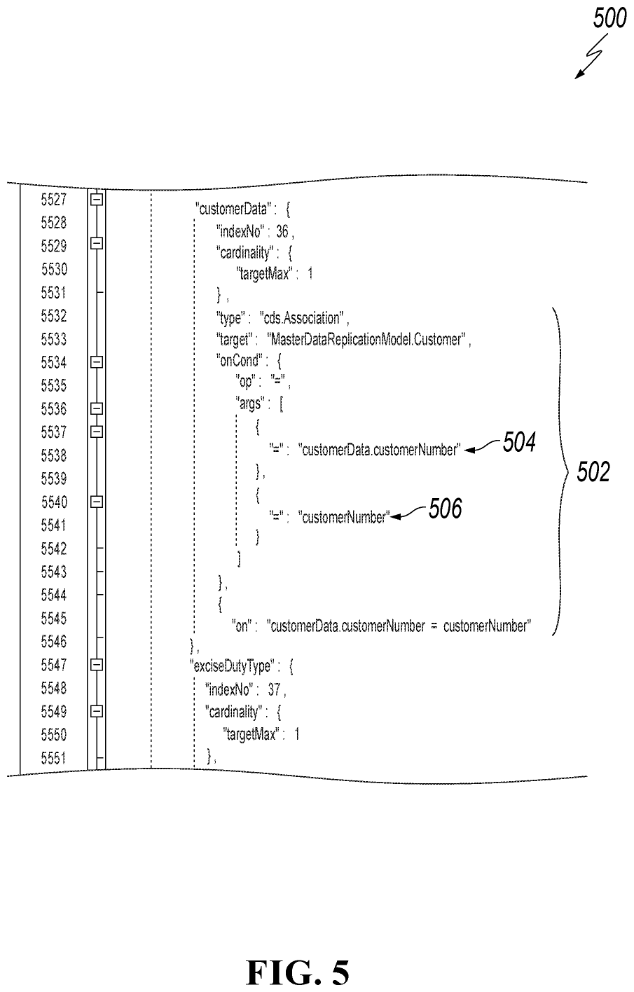

FIG. 5 is a screenshot of the data definition 400, according to an implementation of the present disclosure. In FIG. 5, the displayed portion of the data definition 400 includes association information 502 for client-related information. Specifically, the association information 502 includes association information for client number fields 504 and 506. The association that is defined can be used, for example, in table joins that occur when a query is executed. In some implementations, query results can be presented in dashboards.

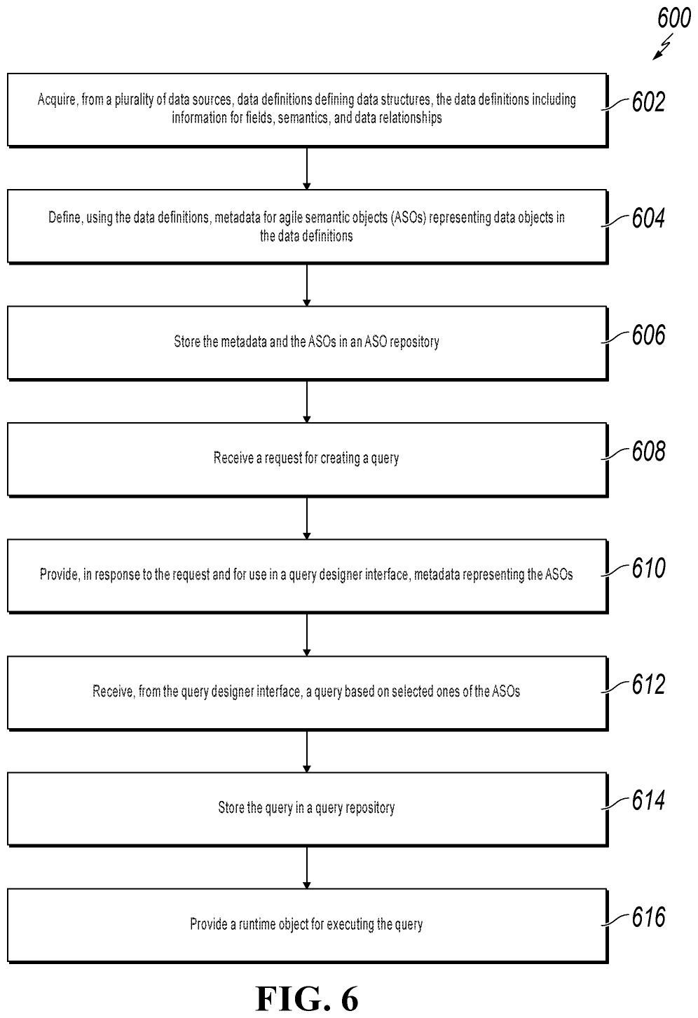

FIG. 6 is a flowchart illustrating an example of a computer-implemented method 600 for defining and using ASOs, according to an implementation of the present disclosure. For clarity of presentation, the description that follows generally describes method 600 in the context of the other figures in this description. However, it will be understood that method 600 can be performed, for example, by any system, environment, software, and hardware, or a combination of systems, environments, software, and hardware, as appropriate. In some implementations, various steps of method 600 can be run in parallel, in combination, in loops, or in any order.

At 602, data definitions defining data structures are acquired from a plurality of data sources. The data definitions include information for fields, semantics, and data relationships and semantics for use in analytical environments. For example, the user 202 can provide data definitions in the form of examples provided in FIGS. 4 and 5. From 602, method 600 proceeds to 604.

At 604, using the data definitions, metadata is defined for agile semantic objects (ASOs) representing data objects in the data definitions. The ASF, for example, can generate ASOs from the data definitions provided by the user 202. In some implementations, the ASOs can be the data definitions themselves or portions of the data definitions. From 604, method 600 proceeds to 606.

At 606, the metadata and the ASOs are stored in an ASO repository. For example, the application router 206 can provide the ASOs to the ASO repository 212. From 606, method 600 proceeds to 608.

At 608, a request for creating a query is received. As an example, the SAC query designer 204 can receive the request 218 provided by the user 202. From 608, method 600 proceeds to 610.

At 610, metadata representing the ASOs is provided in response to the request for use in a query designer interface. For example, the ASO repository 212 can provide the ASOs that forwarded back to the user 202. From 610, method 600 proceeds to 612.

At 612, a query based on selected ones of the ASOs is received from the query designer interface. The user 202, for example, can provide a query through the SAC query designer 204. From 612, method 600 proceeds to 614.

At 614, the query is stored in a query repository. From 614, method 600 proceeds to 616.

At 616, a runtime object for executing the query is provided. As an example, the ASO repository 212 can return a query runtime object for the user's query to the application router 206 which can forward the query runtime object to the SAC query designer 204. After 616, method 600 can stop.

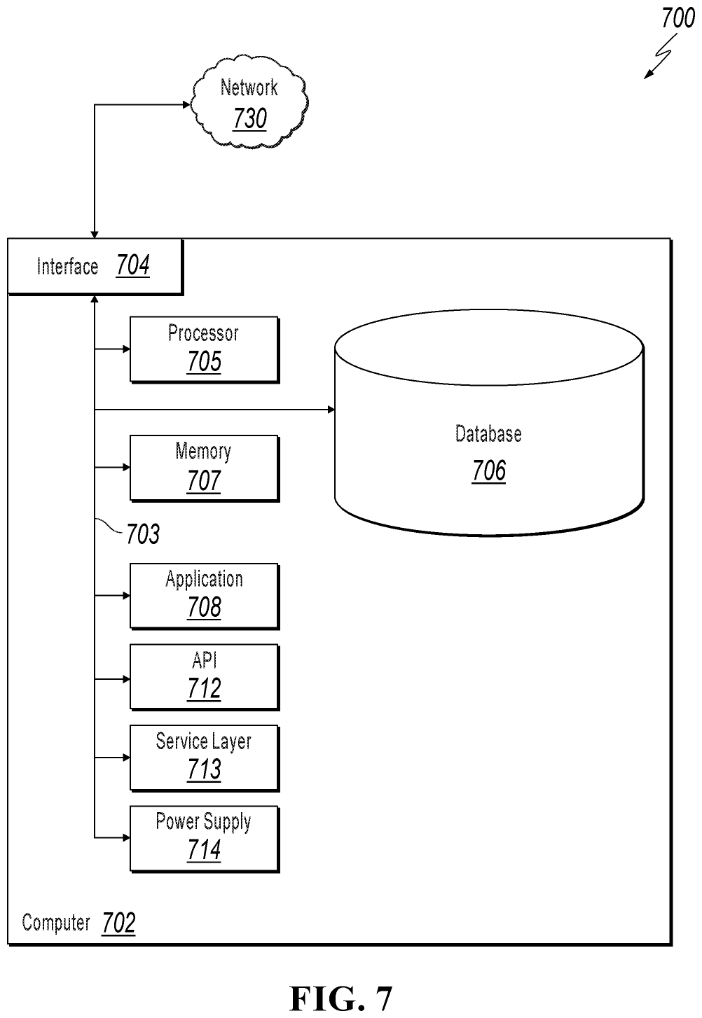

FIG. 7 is a block diagram illustrating an example of a computer-implemented System 700 used to provide computational functionalities associated with described algorithms, methods, functions, processes, flows, and procedures, according to an implementation of the present disclosure. In the illustrated implementation, System 700 includes a Computer 702 and a Network 730.

The illustrated Computer 702 is intended to encompass any computing device, such as a server, desktop computer, laptop/notebook computer, wireless data port, smart phone, personal data assistant (PDA), tablet computer, one or more processors within these devices, or a combination of computing devices, including physical or virtual instances of the computing device, or a combination of physical or virtual instances of the computing device. Additionally, the Computer 702 can include an input device, such as a keypad, keyboard, or touch screen, or a combination of input devices that can accept user information, and an output device that conveys information associated with the operation of the Computer 702, including digital data, visual, audio, another type of information, or a combination of types of information, on a graphical-type user interface (UI) (or GUI) or other UI.

The Computer 702 can serve in a role in a distributed computing system as, for example, a client, network component, a server, or a database or another persistency, or a combination of roles for performing the subject matter described in the present disclosure. The illustrated Computer 702 is communicably coupled with a Network 730. In some implementations, one or more components of the Computer 702 can be configured to operate within an environment, or a combination of environments, including cloud-computing, local, or global.

At a high level, the Computer 702 is an electronic computing device operable to receive, transmit, process, store, or manage data and information associated with the described subject matter. According to some implementations, the Computer 702 can also include or be communicably coupled with a server, such as an application server, e-mail server, web server, caching server, or streaming data server, or a combination of servers.

The Computer 702 can receive requests over Network 730 (for example, from a client software application executing on another Computer 702) and respond to the received requests by processing the received requests using a software application or a combination of software applications. In addition, requests can also be sent to the Computer 702 from internal users (for example, from a command console or by another internal access method), external or third-parties, or other entities, individuals, systems, or computers.

Each of the components of the Computer 702 can communicate using a System Bus 703. In some implementations, any or all of the components of the Computer 702, including hardware, software, or a combination of hardware and software, can interface over the System Bus 703 using an application programming interface (API) 712, a Service Layer 713, or a combination of the API 712 and Service Layer 713. The API 712 can include specifications for routines, data structures, and object classes. The API 712 can be either computer-language independent or dependent and refer to a complete interface, a single function, or even a set of APIs. The Service Layer 713 provides software services to the Computer 702 or other components (whether illustrated or not) that are communicably coupled to the Computer 702. The functionality of the Computer 702 can be accessible for all service consumers using the Service Layer 713. Software services, such as those provided by the Service Layer 713, provide reusable, defined functionalities through a defined interface. For example, the interface can be software written in a computing language (for example JAVA or C++) or a combination of computing languages, and providing data in a particular format (for example, extensible markup language (XML)) or a combination of formats. While illustrated as an integrated component of the Computer 702, alternative implementations can illustrate the API 712 or the Service Layer 713 as stand-alone components in relation to other components of the Computer 702 or other components (whether illustrated or not) that are communicably coupled to the Computer 702. Moreover, any or all parts of the API 712 or the Service Layer 713 can be implemented as a child or a sub-module of another software module, enterprise application, or hardware module without departing from the scope of the present disclosure.

The Computer 702 includes an Interface 704. Although illustrated as a single Interface 704, two or more Interfaces 704 can be used according to particular needs, desires, or particular implementations of the Computer 702. The Interface 704 is used by the Computer 702 for communicating with another computing system (whether illustrated or not) that is communicatively linked to the Network 730 in a distributed environment. Generally, the Interface 704 is operable to communicate with the Network 730 and includes logic encoded in software, hardware, or a combination of software and hardware. More specifically, the Interface 704 can include software supporting one or more communication protocols associated with communications such that the Network 730 or hardware of Interface 704 is operable to communicate physical signals within and outside of the illustrated Computer 702.

The Computer 702 includes a Processor 705. Although illustrated as a single Processor 705, two or more Processors 705 can be used according to particular needs, desires, or particular implementations of the Computer 702. Generally, the Processor 705 executes instructions and manipulates data to perform the operations of the Computer 702 and any algorithms, methods, functions, processes, flows, and procedures as described in the present disclosure.

The Computer 702 also includes a Database 706 that can hold data for the Computer 702, another component communicatively linked to the Network 730 (whether illustrated or not), or a combination of the Computer 702 and another component. For example, Database 706 can be an in-memory or conventional database storing data consistent with the present disclosure. In some implementations, Database 706 can be a combination of two or more different database types (for example, a hybrid in-memory and conventional database) according to particular needs, desires, or particular implementations of the Computer 702 and the described functionality. Although illustrated as a single Database 706, two or more databases of similar or differing types can be used according to particular needs, desires, or particular implementations of the Computer 702 and the described functionality. While Database 706 is illustrated as an integral component of the Computer 702, in alternative implementations, Database 706 can be external to the Computer 702.

The Computer 702 also includes a Memory 707 that can hold data for the Computer 702, another component or components communicatively linked to the Network 730 (whether illustrated or not), or a combination of the Computer 702 and another component. Memory 707 can store any data consistent with the present disclosure. In some implementations, Memory 707 can be a combination of two or more different types of memory (for example, a combination of semiconductor and magnetic storage) according to particular needs, desires, or particular implementations of the Computer 702 and the described functionality. Although illustrated as a single Memory 707, two or more Memories 707 or similar or differing types can be used according to particular needs, desires, or particular implementations of the Computer 702 and the described functionality. While Memory 707 is illustrated as an integral component of the Computer 702, in alternative implementations, Memory 707 can be external to the Computer 702.

The Application 708 is an algorithmic software engine providing functionality according to particular needs, desires, or particular implementations of the Computer 702, particularly with respect to functionality described in the present disclosure. For example, Application 708 can serve as one or more components, modules, or applications. Further, although illustrated as a single Application 708, the Application 708 can be implemented as multiple Applications 708 on the Computer 702. In addition, although illustrated as integral to the Computer 702, in alternative implementations, the Application 708 can be external to the Computer 702.

The Computer 702 can also include a Power Supply 714. The Power Supply 714 can include a rechargeable or non-rechargeable battery that can be configured to be either user- or non-user-replaceable. In some implementations, the Power Supply 714 can include power-conversion or management circuits (including recharging, standby, or another power management functionality). In some implementations, the Power Supply 714 can include a power plug to allow the Computer 702 to be plugged into a wall socket or another power source to, for example, power the Computer 702 or recharge a rechargeable battery.

There can be any number of Computers 702 associated with, or external to, a computer system containing Computer 702, each Computer 702 communicating over Network 730. Further, the term “client,” “user,” or other appropriate terminology can be used interchangeably, as appropriate, without departing from the scope of the present disclosure. Moreover, the present disclosure contemplates that many users can use one Computer 702, or that one user can use multiple computers 702.

Described implementations of the subject matter can include one or more features, alone or in combination.

For example, in a first implementation, a computer-implemented method comprising: acquiring, from a plurality of data sources, data definitions defining data structures, the data definitions including information for fields, semantics, and data relationships and semantics for use in analytical environments; defining, using the data definitions, metadata for agile semantic objects (ASOs) representing data objects in the data definitions; storing the metadata and the ASOs in an ASO repository; receiving a request for creating a query; providing, in response to the request and for use in a query designer interface, metadata representing the ASOs; receiving, from the query designer interface, a query based on selected ones of the ASOs; and storing the query in a query repository; and providing a runtime object for executing the query.

The foregoing and other described implementations can each, optionally, include one or more of the following features:

A first feature, combinable with any of the following features, wherein the data definitions are stored in JSON or XML format.

A second feature, combinable with any of the previous or following features, wherein the metadata is provided in a visual, hierarchal format.

A third feature, combinable with any of the previous or following features, wherein storing the metadata and the ASOs in an ASO repository includes storing indexes for the data definitions.

A fourth feature, combinable with any of the previous or following features, wherein the ASO repository is stored in the cloud or on premises.

A fifth feature, combinable with any of the previous or following features, wherein acquiring the data definitions defining the data structures includes performing an intelligent automated discovery of semantical information in the data definitions and characterizing the data definitions using technical properties and ontological knowledge of former patterns in previously-acquired data definitions.

A sixth feature, combinable with any of the previous or following features, further comprising: receiving the runtime object for executing the query; and executing the query against the ASO repository and providing query results.

In a second implementation, a non-transitory, computer-readable medium storing one or more instructions executable by a computer system to perform operations comprising: acquiring, from a plurality of data sources, data definitions defining data structures, the data definitions including information for fields, semantics, and data relationships and semantics for use in analytical environments; defining, using the data definitions, metadata for ASOs representing data objects in the data definitions; storing the metadata and the ASOs in an ASO repository; receiving a request for creating a query; providing, in response to the request and for use in a query designer interface, metadata representing the ASOs; receiving, from the query designer interface, a query based on selected ones of the ASOs; and storing the query in a query repository; and providing a runtime object for executing the query.

The foregoing and other described implementations can each, optionally, include one or more of the following features:

A first feature, combinable with any of the following features, wherein the data definitions are stored in JSON or XML format.

A second feature, combinable with any of the previous or following features, wherein the metadata is provided in a visual, hierarchal format.

A third feature, combinable with any of the previous or following features, wherein storing the metadata and the ASOs in an ASO repository includes storing indexes for the data definitions.

A fourth feature, combinable with any of the previous or following features, wherein the ASO repository is stored in the cloud or on premises.

A fifth feature, combinable with any of the previous or following features, wherein acquiring the data definitions defining the data structures includes performing an intelligent automated discovery of semantical information in the data definitions and characterizing the data definitions using technical properties and ontological knowledge of former patterns in previously-acquired data definitions.

A sixth feature, combinable with any of the previous or following features, the operations further comprising: receiving the runtime object for executing the query; and executing the query against the ASO repository and providing query results.

In a third implementation, a computer-implemented system, comprising: one or more computers; and one or more computer memory devices interoperably coupled with the one or more computers and having tangible, non-transitory, machine-readable media storing one or more instructions that, when executed by the one or more computers, perform one or more operations comprising: acquiring, from a plurality of data sources, data definitions defining data structures, the data definitions including information for fields, semantics, and data relationships and semantics for use in analytical environments; defining, using the data definitions, metadata for ASOs representing data objects in the data definitions; storing the metadata and the ASOs in an ASO repository; receiving a request for creating a query; providing, in response to the request and for use in a query designer interface, metadata representing the ASOs; receiving, from the query designer interface, a query based on selected ones of the ASOs; and storing the query in a query repository; and providing a runtime object for executing the query.

The foregoing and other described implementations can each, optionally, include one or more of the following features:

A first feature, combinable with any of the following features, wherein the data definitions are stored in JSON or XML format.

A second feature, combinable with any of the previous or following features, wherein the metadata is provided in a visual, hierarchal format.

A third feature, combinable with any of the previous or following features, wherein storing the metadata and the ASOs in an ASO repository includes storing indexes for the data definitions.

A fourth feature, combinable with any of the previous or following features, wherein the ASO repository is stored in the cloud or on premises.

A fifth feature, combinable with any of the previous or following features, wherein acquiring the data definitions defining the data structures includes performing an intelligent automated discovery of semantical information in the data definitions and characterizing the data definitions using technical properties and ontological knowledge of former patterns in previously-acquired data definitions.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs, that is, one or more modules of computer program instructions encoded on a tangible, non-transitory, computer-readable medium for execution by, or to control the operation of, a computer or computer-implemented system. Alternatively, or additionally, the program instructions can be encoded in/on an artificially generated propagated signal, for example, a machine-generated electrical, optical, or electromagnetic signal that is generated to encode information for transmission to a receiver apparatus for execution by a computer or computer-implemented system. The computer-storage medium can be a machine-readable storage device, a machine-readable storage substrate, a random or serial access memory device, or a combination of computer-storage mediums. Configuring one or more computers means that the one or more computers have installed hardware, firmware, or software (or combinations of hardware, firmware, and software) so that when the software is executed by the one or more computers, particular computing operations are performed.

The term “real-time,” “real time,” “realtime,” “real (fast) time (RFT),” “near(ly) real-time (NRT),” “quasi real-time,” or similar terms (as understood by one of ordinary skill in the art), means that an action and a response are temporally proximate such that an individual perceives the action and the response occurring substantially simultaneously. For example, the time difference for a response to display (or for an initiation of a display) of data following the individual's action to access the data can be less than 1 millisecond (ms), less than 1 second (s), or less than 5 s. While the requested data need not be displayed (or initiated for display) instantaneously, it is displayed (or initiated for display) without any intentional delay, taking into account processing limitations of a described computing system and time required to, for example, gather, accurately measure, analyze, process, store, or transmit the data.

The terms “data processing apparatus,” “computer,” or “electronic computer device” (or an equivalent term as understood by one of ordinary skill in the art) refer to data processing hardware and encompass all kinds of apparatuses, devices, and machines for processing data, including by way of example, a programmable processor, a computer, or multiple processors or computers. The computer can also be, or further include special-purpose logic circuitry, for example, a central processing unit (CPU), a field programmable gate array (FPGA), or an application-specific integrated circuit (ASIC). In some implementations, the computer or computer-implemented system or special-purpose logic circuitry (or a combination of the computer or computer-implemented system and special-purpose logic circuitry) can be hardware- or software-based (or a combination of both hardware- and software-based). The computer can optionally include code that creates an execution environment for computer programs, for example, code that constitutes processor firmware, a protocol stack, a database management system, an operating system, or a combination of execution environments. The present disclosure contemplates the use of a computer or computer-implemented system with an operating system, for example LINUX, UNIX, WINDOWS, MAC OS, ANDROID, or IOS, or a combination of operating systems.

A computer program, which can also be referred to or described as a program, software, a software application, a unit, a module, a software module, a script, code, or other component can be written in any form of programming language, including compiled or interpreted languages, or declarative or procedural languages, and it can be deployed in any form, including, for example, as a stand-alone program, module, component, or subroutine, for use in a computing environment. A computer program can, but need not, correspond to a file in a file system. A program can be stored in a portion of a file that holds other programs or data, for example, one or more scripts stored in a markup language document, in a single file dedicated to the program in question, or in multiple coordinated files, for example, files that store one or more modules, sub-programs, or portions of code. A computer program can be deployed to be executed on one computer or on multiple computers that are located at one site or distributed across multiple sites and interconnected by a communication network.

While portions of the programs illustrated in the various figures can be illustrated as individual components, such as units or modules, that implement described features and functionality using various objects, methods, or other processes, the programs can instead include a number of sub-units, sub-modules, third-party services, components, libraries, and other components, as appropriate. Conversely, the features and functionality of various components can be combined into single components, as appropriate. Thresholds used to make computational determinations can be statically, dynamically, or both statically and dynamically determined.

Described methods, processes, or logic flows represent one or more examples of functionality consistent with the present disclosure and are not intended to limit the disclosure to the described or illustrated implementations, but to be accorded the widest scope consistent with described principles and features. The described methods, processes, or logic flows can be performed by one or more programmable computers executing one or more computer programs to perform functions by operating on input data and generating output data. The methods, processes, or logic flows can also be performed by, and computers can also be implemented as, special-purpose logic circuitry, for example, a CPU, an FPGA, or an ASIC.

Computers for the execution of a computer program can be based on general or special-purpose microprocessors, both, or another type of CPU. Generally, a CPU will receive instructions and data from and write to a memory. The essential elements of a computer are a CPU, for performing or executing instructions, and one or more memory devices for storing instructions and data. Generally, a computer will also include, or be operatively coupled to, receive data from or transfer data to, or both, one or more mass storage devices for storing data, for example, magnetic, magneto-optical disks, or optical disks. However, a computer need not have such devices. Moreover, a computer can be embedded in another device, for example, a mobile telephone, a personal digital assistant (PDA), a mobile audio or video player, a game console, a global positioning system (GPS) receiver, or a portable memory storage device.

Non-transitory computer-readable media for storing computer program instructions and data can include all forms of permanent/non-permanent or volatile/non-volatile memory, media and memory devices, including by way of example semiconductor memory devices, for example, random access memory (RAM), read-only memory (ROM), phase change memory (PRAM), static random access memory (SRAM), dynamic random access memory (DRAM), erasable programmable read-only memory (EPROM), electrically erasable programmable read-only memory (EEPROM), and flash memory devices; magnetic devices, for example, tape, cartridges, cassettes, internal/removable disks; magneto-optical disks; and optical memory devices, for example, digital versatile/video disc (DVD), compact disc (CD)-ROM, DVD+/−R, DVD-RAM, DVD-ROM, high-definition/density (HD)-DVD, and BLU-RAY/BLU-RAY DISC (BD), and other optical memory technologies. The memory can store various objects or data, including caches, classes, frameworks, applications, modules, backup data, jobs, web pages, web page templates, data structures, database tables, repositories storing dynamic information, or other appropriate information including any parameters, variables, algorithms, instructions, rules, constraints, or references. Additionally, the memory can include other appropriate data, such as logs, policies, security or access data, or reporting files. The processor and the memory can be supplemented by, or incorporated in, special-purpose logic circuitry.

To provide for interaction with a user, implementations of the subject matter described in this specification can be implemented on a computer having a display device, for example, a cathode ray tube (CRT), liquid crystal display (LCD), light emitting diode (LED), or plasma monitor, for displaying information to the user and a keyboard and a pointing device, for example, a mouse, trackball, or trackpad by which the user can provide input to the computer. Input can also be provided to the computer using a touchscreen, such as a tablet computer surface with pressure sensitivity or a multi-touch screen using capacitive or electric sensing. Other types of devices can be used to interact with the user. For example, feedback provided to the user can be any form of sensory feedback (such as, visual, auditory, tactile, or a combination of feedback types). Input from the user can be received in any form, including acoustic, speech, or tactile input. In addition, a computer can interact with the user by sending documents to and receiving documents from a client computing device that is used by the user (for example, by sending web pages to a web browser on a user's mobile computing device in response to requests received from the web browser).

The term “graphical user interface,” or “GUI,” can be used in the singular or the plural to describe one or more graphical user interfaces and each of the displays of a particular graphical user interface. Therefore, a GUI can represent any graphical user interface, including but not limited to, a web browser, a touch screen, or a command line interface (CLI) that processes information and efficiently presents the information results to the user. In general, a GUI can include a number of user interface (UI) elements, some or all associated with a web browser, such as interactive fields, pull-down lists, and buttons. These and other UI elements can be related to or represent the functions of the web browser.

Implementations of the subject matter described in this specification can be implemented in a computing system that includes a back-end component, for example, as a data server, or that includes a middleware component, for example, an application server, or that includes a front-end component, for example, a client computer having a graphical user interface or a Web browser through which a user can interact with an implementation of the subject matter described in this specification, or any combination of one or more such back-end, middleware, or front-end components. The components of the system can be interconnected by any form or medium of wireline or wireless digital data communication (or a combination of data communication), for example, a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) using, for example, 802.11 a/b/g/n or 802.20 (or a combination of 802.11x and 802.20 or other protocols consistent with the present disclosure), all or a portion of the Internet, another communication network, or a combination of communication networks. The communication network can communicate with, for example, Internet Protocol (IP) packets, frame relay frames, Asynchronous Transfer Mode (ATM) cells, voice, video, data, or other information between network nodes.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any inventive concept or on the scope of what can be claimed, but rather as descriptions of features that can be specific to particular implementations of particular inventive concepts. Certain features that are described in this specification in the context of separate implementations can also be implemented, in combination, in a single implementation. Conversely, various features that are described in the context of a single implementation can also be implemented in multiple implementations, separately, or in any sub-combination. Moreover, although previously described features can be described as acting in certain combinations and even initially claimed as such, one or more features from a claimed combination can, in some cases, be excised from the combination, and the claimed combination can be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations can be considered optional), to achieve desirable results. In certain circumstances, multitasking or parallel processing (or a combination of multitasking and parallel processing) can be advantageous and performed as deemed appropriate.

Moreover, the separation or integration of various system modules and components in the previously described implementations should not be understood as requiring such separation or integration in all implementations, and it should be understood that the described program components and systems can generally be integrated together in a single software product or packaged into multiple software products.

Accordingly, the previously described example implementations do not define or constrain the present disclosure. Other changes, substitutions, and alterations are also possible without departing from the spirit and scope of the present disclosure.

Furthermore, any claimed implementation is considered to be applicable to at least a computer-implemented method; a non-transitory, computer-readable medium storing computer-readable instructions to perform the computer-implemented method; and a computer system comprising a computer memory interoperably coupled with a hardware processor configured to perform the computer-implemented method or the instructions stored on the non-transitory, computer-readable medium.

What is claimed is:

1. A computer-implemented method, comprising:
acquiring, from a plurality of data sources, data definitions defining data structures, the data definitions including information for fields, semantics, and data relationships and semantics for use in analytical environments;
defining, using the data definitions, metadata for agile semantic objects (ASOs) representing data objects in the data definitions;
storing the metadata and the ASOs in an ASO repository;
receiving a request for creating a query;
providing, in response to the request and for use in a query designer interface, metadata representing the ASOs;
receiving, from the query designer interface, a query based on selected ones of the ASOs;
storing the query in a query repository; and
providing a runtime object for executing the query.

2. The computer-implemented method of claim 1, wherein the data definitions are stored in JAVASCRIPT OBJECT NOTATION (JSON) or extensible markup language (XML) format.

3. The computer-implemented method of claim 1, wherein the metadata is provided in a visual, hierarchal format.

4. The computer-implemented method of claim 1, wherein storing the metadata and the ASOs in an ASO repository includes storing indexes for the data definitions.

5. The computer-implemented method of claim 1, wherein the ASO repository is stored in the cloud or on premises.

6. The computer-implemented method of claim 1, wherein acquiring the data definitions defining the data structures includes performing an intelligent automated discovery of semantical information in the data definitions and characterizing the data definitions using technical properties and ontological knowledge of former patterns in previously-acquired data definitions.

7. The computer-implemented method of claim 1, further comprising:
receiving the runtime object for executing the query; and
executing the query against the ASO repository and providing query results.

8. A non-transitory, computer-readable medium storing one or more instructions executable by a computer system to perform operations comprising:
acquiring, from a plurality of data sources, data definitions defining data structures, the data definitions including information for fields, semantics, and data relationships and semantics for use in analytical environments;
defining, using the data definitions, metadata for ASOs representing data objects in the data definitions;
storing the metadata and the ASOs in an ASO repository;
receiving a request for creating a query;
providing, in response to the request and for use in a query designer interface, metadata representing the ASOs;
receiving, from the query designer interface, a query based on selected ones of the ASOs;
storing the query in a query repository; and
providing a runtime object for executing the query.

9. The non-transitory, computer-readable medium of claim 8, wherein the data definitions are stored in JSON or XML format.

10. The non-transitory, computer-readable medium of claim 8, wherein the metadata is provided in a visual, hierarchal format.

11. The non-transitory, computer-readable medium of claim 8, wherein storing the metadata and the ASOs in an ASO repository includes storing indexes for the data definitions.

12. The non-transitory, computer-readable medium of claim 8, wherein the ASO repository is stored in the cloud or on premises.

13. The non-transitory, computer-readable medium of claim 8, wherein acquiring the data definitions defining the data structures includes performing an intelligent automated discovery of semantical information in the data definitions and characterizing the data definitions using technical properties and ontological knowledge of former patterns in previously-acquired data definitions.

14. The non-transitory, computer-readable medium of claim 8, the operations further comprising:
receiving the runtime object for executing the query; and
executing the query against the ASO repository and providing query results.

15. A computer-implemented system, comprising:
one or more computers; and
one or more computer memory devices interoperably coupled with the one or more computers and having tangible, non-transitory, machine-readable media storing one or more instructions that, when executed by the one or more computers, perform one or more operations comprising:
acquiring, from a plurality of data sources, data definitions defining data structures, the data definitions including information for fields, semantics, and data relationships and semantics for use in analytical environments;
defining, using the data definitions, metadata for ASOs representing data objects in the data definitions;
storing the metadata and the ASOs in an ASO repository;
receiving a request for creating a query;
providing, in response to the request and for use in a query designer interface, metadata representing the ASOs;
receiving, from the query designer interface, a query based on selected ones of the ASOs;
storing the query in a query repository; and
providing a runtime object for executing the query.

16. The computer-implemented system of claim 15, wherein the data definitions are stored in JSON or XML format.

17. The computer-implemented system of claim 15, wherein the metadata is provided in a visual, hierarchal format.

18. The computer-implemented system of claim 15, wherein storing the metadata and the ASOs in an ASO repository includes storing indexes for the data definitions.

19. The computer-implemented system of claim 15, wherein the ASO repository is stored in the cloud or on premises.

20. The computer-implemented system of claim 15, wherein acquiring the data definitions defining the data structures includes performing an intelligent automated discovery of semantical information in the data definitions and characterizing the data definitions using technical properties and ontological knowledge of former patterns in previously-acquired data definitions.
